(19) United States
(12) Patent Application Publication
(10) Pub. No.: US 2005/0055544 A1
(43) Pub. Date: Mar. 10, 2005

(54) Central processing unit having a module for processing of function calls

(75) Inventors: Ute Gaertner, Schoenaich (DE); Erwin Pfeffer, Holzgerlingen (DE); Charles F. Webb, Wappingers Falls, NY (US)

Correspondence Address: INTERNATIONAL BUSINESS MACHINES CORPORATION;IP LAW DEPARTMENT, 2455 SOUTH ROAD - MS P386, POUGHKEEPSIE, NY, 12601, US

(73) Assignee: INTERNATIONAL BUSINESS MACHINES CORPORATION, ARMONK, NY (US)

(21) Appl. No.: 10/900,537

(22) Filed: Jul. 28, 2004

(30) Foreign Application Priority Data
Jul. 30, 2003 (DE) 03102371.6

(51) Int. Cl. G06F 15/00

(52) U.S. Cl. 712/242

(57) ABSTRACT

The present invention relates to a central processing unit comprising: (a) a number of functional units (A, B, . . . , N), (b) at least one module for processing of a function call received from one of the functional units, the module having a decoder to obtain an instruction address from the function call, a memory for storing a plurality of control instructions and for storing a plurality of branch instructions, each control instruction having an assigned instruction address for a next instruction and each branch instruction having assigned at least two alternative instruction addresses for a next instruction, first logic circuitry for processing of the branch instructions in order to select one of the at least two alternative instruction addresses of one of the branch instructions, second logic circuitry for processing of the control instructions in order to return a result in response to the function call.

### FIELD OF THE INVENTION

The present invention generally relates to the field of data processing, and more particularly to the processing of function calls of functional units of a central processing unit.

### BACKGROUND OF THE INVENTION

Modern microprocessors have a growing number of sophisticated functions or algorithms implemented in hardwired logic on the processor chip, such as complex address translation schemes supporting numerous virtual machines, data compression and expansion etc. In prior art microprocessor designs, the control part for these functions is based on a state machine: A given function or algorithm is subdivided into unique basic control states and a hardwired decision logic activates one out of the numerous unique states, i. e. switches control from one active state to next one.

This control concept has the following major disadvantages:

Inflexible: Since the complete algorithm is implemented in hardware late design changes are nearly impossible without impacting the cycle time of the execution logic and the area on the chip. Malfunctions found late in the design cycle or even after shipment of the product may require to a disable part or even the complete function.

Scrambled logic: Since each state of the control logic is unique, the usage of common building blocks is impossible.

Difficult to maintain: Trouble shooting requires detailed knowledge of implementation details.

Difficult to implement Single-point-of-failure detection: Modern microprocessors are conceptually designed to detect a singular hardware defect. Prior art to implement this feature in state machine based designs is duplication of the complete control logic and comparison of the both output signal streams.

### SUMMARY OF THE INVENTION

The present invention provides for a central processing unit having at least one module for processing of function calls received from functional units, such as instruction fetch and load/store units. The module has a memory for storing a plurality of control instructions and for storing a plurality of branch instructions.

Each of the control instructions has an assigned instruction address for a next sequential instruction. Each one of the branch instructions has assigned at least two alternative instruction addresses. The branch instruction is processed by dedicated logic circuitry of the module in order to select one of the alternative instruction addresses as a next instruction address.

Further the module has dedicated logic circuitry for processing of the control instructions. This logic circuitry provides a result for the function call which is returned to the calling functional unit or to another functional unit of the central processing unit.

In accordance with a preferred embodiment of the invention the module performs a control intensive data processing task, such as address translation, data compression, data expansion, data encryption or data decryption.

In accordance with a further preferred embodiment of the invention the alternative instruction addresses being assigned to a branch instruction can be addresses of control instructions or addresses of other branch instructions. In the latter case multiple hierarchies of a decision tree for identification of a next sequential control instruction can be implemented.

In accordance with a further preferred embodiment of the invention a branch instruction has a number of four to six alternative instruction addresses. This can include a next sequential instruction (NSI) and a branch-on bit. The branch-on bit enables to handle exceptions for example for checking of corresponding flags.

In accordance with a further preferred embodiment of the invention a control instruction can also have an assigned branch address for the purpose of exception handling. If an exception occurs when the control instruction is executed the control goes to the exceptional branch target as indicated in the control instruction. In case the dedicated logic circuitry has one or more pipeline stages, the pipeline is invalidated in case such an exception occurs.

In accordance with a further preferred embodiment of the invention the procedure including accessing the memory, providing a branch instruction to the corresponding dedicated logic circuitry, determining the branch instruction address by the dedicated logic circuitry and providing the branch instruction address to the memory is executed in one clock cycle, if none of the branch conditions is met. In this case the NSI stored in RAM is taken as the next instruction address. If one of the branch conditions is met an instruction processing delay of up to two cycles is induced.

As opposed to this the dedicated logic which is controlled by the control instructions typically requires multiple clock cycles and has multiple pipeline stages. Typically the number of the pipeline stages corresponds to the complexity of the function which is provided by the dedicated logic.

In accordance with a further preferred embodiment of the invention, an embedded controller is provided, which comprises a small micro controller having its program stored in a small RAM. This embedded controller is also referred to as Picoengine.

The logic of the Picoengine is integrated in the microprocessor; it controls sophisticated parts, i.e. the functional units of the microprocessor and is clocked with the master clock. It thus executes with microprocessor speed.

Preferably the Picoengine meets the following two main requirements:

1. With regard to control performance: The number of cycles to execute a given task is less or equal compared to a state-machine based design.

2. With regard to the occupied area on the chip: The Picoengine does not occupy more area than a state-machine based design.

Area and performance are the ultimate goals in microprocessor design. It is extremely difficult to compete with a state machine in terms of control performance. A state machine has almost no overhead in decision finding to switch from a state to the next one. The only possibility to overcome the state machine performance is to execute a task in a pipelined fashion way, where the mainline control path is given by the instruction sequence stored in RAM. No predecoding is needed at the execution time such that it is not necessary to execute all decision finding logic: The Picoengine thus executes at higher speed, i.e. shorter cycle time, than a state machine.

Preferably the logic circuitry for the branch decision has no pipeline and thus provides one branch decision per clock cycle.

Preferably the logic circuitry for determining the branch targets is designed such that one branch decision is taken per clock cycle.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### DESCRIPTION OF THE DRAWINGS

The subject matter which is regarded as the invention is particularly pointed out and distinctly claimed in the concluding portion of the specification. The invention, however, both as to organization and method of practice, together with further objects and advantages thereof, may best be understood by reference to the following description taken in connection with the accompanying drawings in which:

FIG. 1 is a block diagram of a central processing unit having a module for processing of function calls in accordance with a preferred embodiment of the invention;

FIG. 2 is a flow diagram being illustrative of the operation of the central processing unit of FIG. 1;

FIG. 3 is a block diagram of a further preferred embodiment of the central processing unit;

FIG. 4 is a more detailed block diagram of an implementation of the Picoengine;

FIG. 5 is a table showing the format of a Pico instruction; and

FIG. 6 is a block diagram of the Picoengine with multiple pipeline stages.

### DETAILED DESCRIPTION OF THE INVENTION

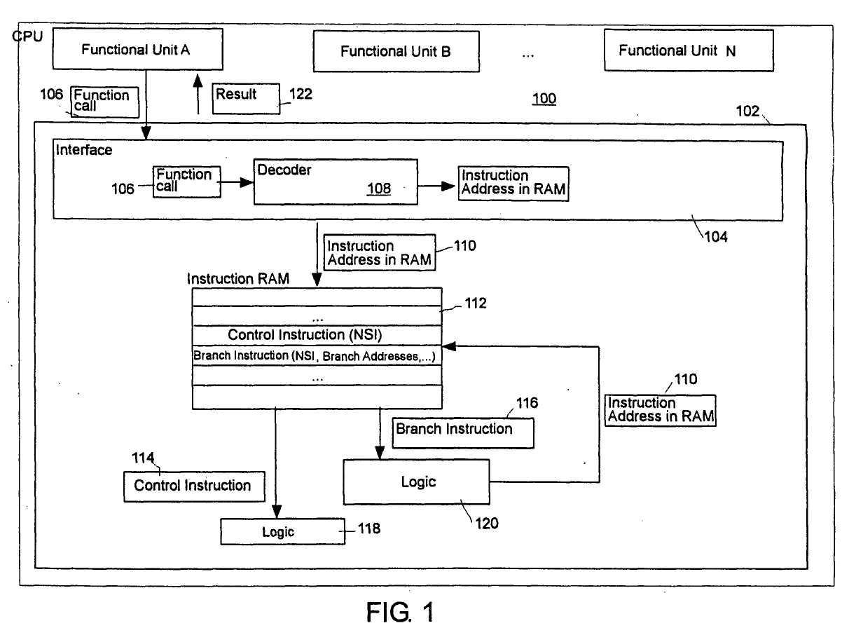

FIG. 1 shows a block diagram of central processing unit (CPU) 100. CPU 100 has a number of functional units A, B . . . , N. For example functional unit A is an instruction fetch unit and functional unit B is a load/store functional unit.

CPU 100 has at least one module 102. Module 102 serves for processing of a particular class of function calls. For example module 102 serves to translate logical addresses to physical addresses or for other relatively complex processing tasks, such as data compression, data encryption or data decryption. Module 102 has interface 104 for receiving function call 106 from functional unit A. Interface 104 has decoder 108 for decoding of function call 106 in order to obtain instruction address 110.

Further module 102 has random access memory (RAM) 112 for storing of control instructions 114 and branch instructions 116. Control instruction 114 has an assigned next sequential instruction (NSI) address which is an instruction address 110 for the next instruction of RAM 112 to be processed. Each branch instruction 116 has at least two alternative branch addresses. Branch instruction 116 may also include a NSI as an additional branching address.

RAM 112 is coupled to logic circuitry 118; the operation of logic circuitry 118 is controlled by control instructions 114. Further RAM 112 is coupled to logic circuitry 120. Logic circuitry 120 serves for processing of branch instructions 116 in order to select one of the alternative branch addresses. The selected branch address is returned as instruction address 110 from logic circuitry 120 to RAM 112 in order to access the next instruction.

The next instruction can either be a control instruction or another branch instruction. In the latter case multiple levels of a decision tree can be implemented in order to determine the next control instruction to be executed by logic circuitry 118.

In operation functional unit A sends function call 106 to module 102. For example function call 106 is a request to translate a given logical address to a physical address. Function call 106 is received by interface 104 and is decoded by means of decoder 108 in order to obtain instruction address 110. Instruction address 110 is used to access one of the instructions stored in RAM 112 which is outputted from RAM 112 either to logic circuitry 118 or to logic circuitry 120 depending on the kind of instruction.

If the instruction identified by instruction address 110 is a control instruction 114, the control instruction 114 is entered into logic circuitry 118; in the opposite case, if the instruction identified by instruction address 110 is a branch instruction, the branch instruction is entered into logic circuitry 120.

When the data processing for the address translation has been completed by logic circuitry 118, result 122 provided by logic circuitry 118 which contains the physical address is returned to the calling functional unit A. Alternatively result 122 is returned to functional unit B which uses result 122 for a data load operation. The functional unit to which result 122 is returned is predetermined within module 102.

Preferably the input of branch instruction 116 from RAM 112 into logic circuitry 120, the determination of instruction address 110 by logic circuitry 120, i.e. the branch target address and accessing of RAM 112 with instruction address 110 is performed in one clock cycle if the branch is not taken but the NSI address from RAM 112 is used. If the branch is taken a delay of up to two clock cycles may be induced to access the instruction of the branch target from RAM 112. However, this is of little impact on the control performance as this path is not the main line control path. Thus no pipeline is created for the execution of branch instructions 116. As opposed to this logic circuitry 118 will typically have one or more pipeline stages depending on the complexity of the data processing function provided by logic circuitry 118.

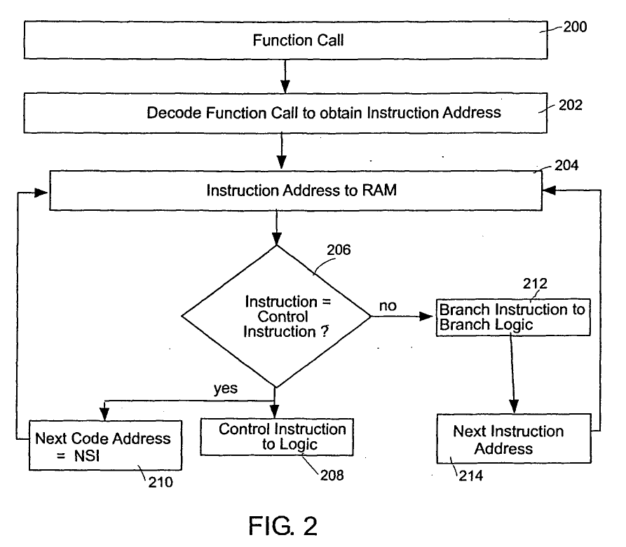

FIG. 2 shows a corresponding flow chart. In step 200 a function call is received from one of the functional units of the CPU. In step 202 the module which has received the function call decodes the function call in order to obtain the instruction address of the first instruction to be executed. By means of the instruction address determined in step 202 the first instruction to be executed is accessed in instruction RAM of the module. This is done in step 204.

In step 206 it is determined whether the first instruction to be executed is a control instruction. If this is the case the control instruction is entered into dedicated logic which serves for processing of control instructions. The control instruction is executed by the dedicated logic circuitry in step 208. Further the NSI which is assigned to the first instruction is determined in step 210 from where the control returns to step 204 in order to start processing of the NSI.

If it is determined in step 206 that the instruction is not a control instruction but a branch instruction, step 212 is executed. In step 212 the branch instruction is entered into dedicated branch logic which serves to identify one of the branch addresses or the NSI being assigned to the branch instruction as the next instruction to be executed.

The resulting next instruction address is provided in step 214; from there the control returns to step 204 in order to start processing of the next instruction as identified by the dedicated branch logic. This procedure continues until the data processing task for processing of the function call has been completed.

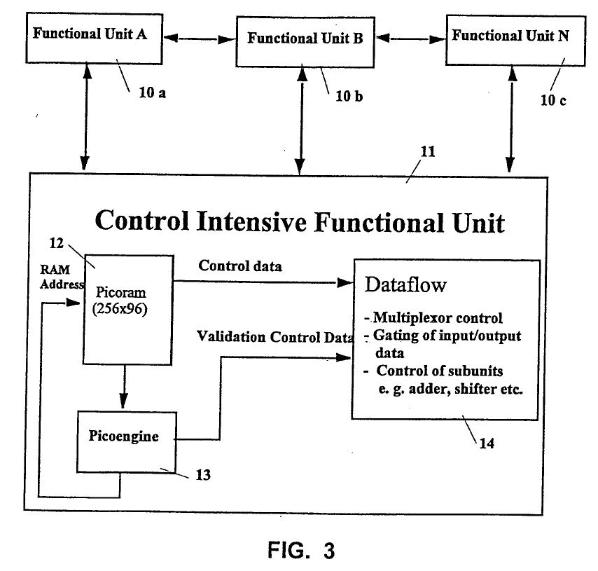

FIG. 3 shows a block diagram of a further preferred embodiment of a central processing unit.

A CPU is typically composed of several Functional Units 10a, 10b, 10c, . . . , such as Fixed-point-Unit, Floating-point-unit, Load-store-unit, etc. All of these units have their own built-in control units, usually based on state machines. Units requiring intensive control, such as an Address-translation-unit 11 are controlled by an embedded Controller, composed of Picocode RAM 12 and Picoengine 13. The instruction layout is such, that most of the data bits of the instruction are directly fed to the dataflow part 14 of the unit and control multiplexors, etc.

It is the task of the Picoengine to signal to the dataflow in which processor cycle the data are usable (validation of the control data). Part of the bits are used by the Picoengine itself, e.g. to calculate the next address in Picocode RAM, or to control the communication with other functional units of the microprocessor. Since the picoengine instruction format contains different independent groups of control bits, the format of the instruction is horizontally organized.

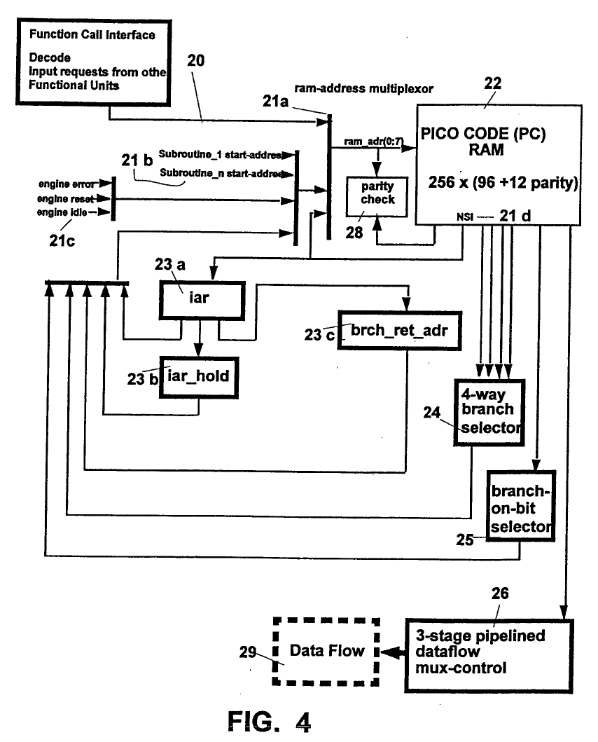

With reference to FIG. 4, before any function call can be performed, the Picocode RAM holding picocode that controls the operation of the Picoengine, must be initialized with the appropriate picocode routines. There are two cases when the picocode must be loaded. First, during IML (Initial Microprogram Load) the Picocode is loaded as part of hardware initialization process. Second, during hardware instruction retry, when a parity error is detected in the Picocode RAM. The Picocode Load operation is completely hardwired without functional support of another unit. The Picocode is loaded from main memory locations. These locations cannot be read by an application program.

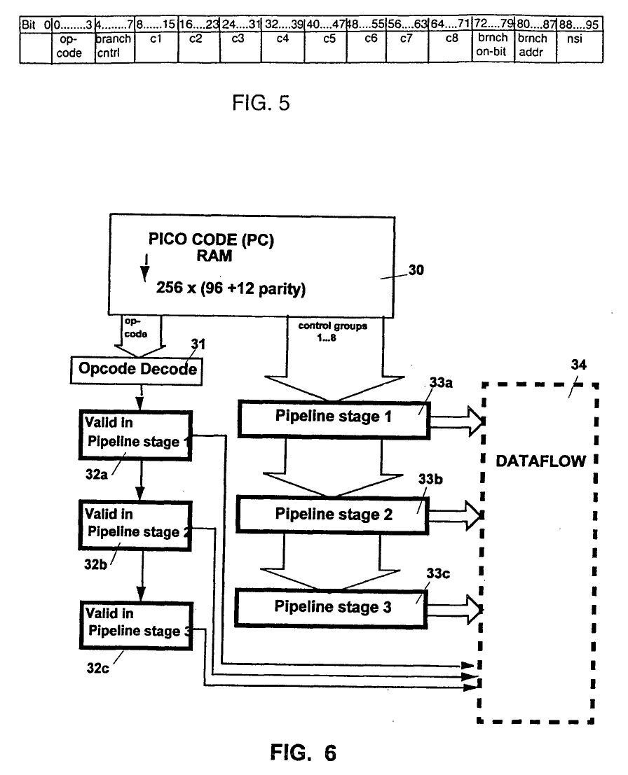

Typically, the picocode instruction format is much wider than the format of a normal ASSEMBLER instruction. In our preferred embodiment, the format is 96 bit wide comprising 8 control fields (c1 . . . c8), as shown in FIG. 5, for parallel execution of different translator functions (horizontally organized). The number of control fields depend on the number of different functions necessary to control the data flow part and internal functions, such as the data exchange with other units.

Usage of these eight control fields for 4 branch conditions with the associated 4 different branch addresses, depending on the opcode (see Tab.2: Control Field Assignment), is advantageous. If the mnemonic specifies a CTL instruction then c1 . . . c8 are used for control purposes, and in case of an MBR (multiple branch) instruction then c1 . . . c8 are used by the Picoengine for branch processing. The branch conditions are tested in a preset priority. In our preferred embodiment, the branch condition with the lowest index is taken first.

Bits 0 . . . 3 contain the opcode of the Picoinstruction. Depending on the opcode, the control fields c1 . . . c8 can be used differently, i. e. for one given opcode c1 . . . c8 control one part of the data flow and the same control bits may be used for other control purposes if another opcode is specified.

Bits 4-7 are used to select different branch functions, e. g. branch to subroutine or return from subroutine and 2 bits specify a subroutine number.

Bits 72-79 are decoded and select different branch conditions. Again, the number of different conditions depends on the application itself, in our preferred embodiment, there are 256 different branch conditions possible. A branch is taken, if a specific condition is set to the true state. This function is therefore called ‘branch on bit’.

Bits 80-87 contain the branch address to which control is transferred, if the branch condition in Bits 72 . . . 79 is met.

Bits 88 . . . 95 contain the address of the next sequential instruction (NSI). It is an essential performance feature of the present invention to have the NSI address stored in the instruction text itself. This allows to transfer control to any Picocode location without branching. A branch operation would require several processor cycles, but with this feature, unconditional branches are executed without any additional delay, necessary to compete with the control performance of a state machine.

FIG. 4 shows a detailed block diagram of the Picoengine. There are four different modes of operation to be distinguished:

1. Engine busy: Whenever a function-call from another unit is received (20) the Picoengine is transferred from the idle to the busy mode. It is an important feature of the microarchitecture that different function-calls force different initial addresses, the start addresses of the execution routines (21a). As shown above, the next sequential instruction (21d) is achieved from the Picoinstruction, currently read out from RAM. With the last control instruction the engine control program branches to an instruction, which turns on the engine idle state.

2. Engine idle: If no function-call is active on the engine, control is transferred to a MBR (branch) instruction, which loops on itself. In this mode the engine is ready to receive new function calls.

3. Engine error: It is an important reliability feature of the Picoengine that all data and control flows are parity checked and all multiplexors must have one and only one input gate enabled. The address applied to the RAM does contain correct parity and the data stored under this address does contain the same parity bit. Both parity bits, if set to equal state, secure that the address decoders of the RAM operate properly (28). These error checker logic guarantees that the Picoengine itself detects ‘single-point-of-failure’ in the hardware circuitries. Whenever a failure is detected the engine forces an RAM address and executes picocode, which signals the occurrence of the failure to the recovery unit. The recovery unit turns on a state called engine reset (21c).

4. Engine reset: In this state the picoengine reloads its control program from main memory. The recovery unit sets all control registers. arrays, and latches to an initial state and forces re-execution of the microprocessor instruction, which showed the failure. This means the Picoengine can recover from a ‘single point of failure’, which is seen to be an important feature of the present invention.

In the ‘busy’ state of the engine the address applied to the Picocode RAM has one of the following origins:

As shown above, the initial address is forced by decoding a function-call into a unique RAM address 20. This action transfers the engine into the busy state.

In the ‘busy’ state the next sequential instruction (NSI) is stored in the RAM 22 itself. This address is taken if no branch request is active. This address is also latched in the ‘iar’ (instruction address register) 23a and ‘iar-hold’ register file 23b to be constantly applied to the RAM if the engine has to wait for another event, e. g. for data from the caches. In this case progress in the control program takes only place after the event occurs; this characteristic is called event-driven and is an important feature of the Picoengine.

A further important feature of the Picoengine is a hardware supported branch-return-stack. The present invention shows only one level of branch-return address 23c, but there may be several levels, depending on the control requirements. The contents of ‘brch_ret_adr’ 23c is the address of the next Picoinstruction after return of a subroutine call. A subroutine call is free-programmable; it is initiated in Bits 4 . . . 7 of the Picocode instruction (see Picocode instruction format). In this case the next instruction address is taken from a subroutine-address stack 21b.

As shown above the Picoengine supports conditional branches, either as branch-on-bit 25 or as n-waymulti-branch 24 basis.

An important feature of the Picoengine is the validation of control data fed from the Picocode RAM directly to the dataflow part of the functional unit. With reference to FIG. 6 control bits of the control groups 1 . . . 8 (30) are latched in pipeline stage 1 (33a) die output of pipeline stage 1 is latched in pipeline stage 2 (33b) etc., i. e. data in each stage are delayed by one clock cycle. This means, if we assume data in stage 3 (33c) belong to Picoinstruction (n), then data in stage 2 belong to Picoinstruction (n+1) and data in stage 1 to (n+2).

The Picoengine decodes the opcode and if the engine is busy, it provides for all different opcodes (only one shown in FIG. 6) a ‘Valid in Pipeline stage 1’ (32a), or stage 2 (32b) or stage 3 (32c). A control action to the data flow will only be activated if both conditions become true: a decoded control function from the control groups and the corresponding valid signal from the opcode decode 31.

The number of chosen pipeline stages should be equal to the number of stages to process data in the dataflow. If so, then all data flow control signals can be derived from Picocode data.

Some of the advantages of a Picoengine based control scheme are as follows:

1. All data flow functions are free-programmable: Each unique data flow control function is decoded, or as singular control bit stored in the Picocode RAM.

2. This feature is very important if the data flow control is very complex and design changes are necessary very late in the design cycle or after the product is shipped to the customer.

3. Design changes do not affected the cycle time of the control data flow. This is an extremely valuable feature, since hardwired control logic changes may necessitate to restart the complete cycle time optimization process for this unit, which may require days or even weeks processing time on large computer systems.

4. The data flow control signals are available very early in the clock cycle. They are latched in the pipeline stages 1 . . . 3 (33a..c). This allows buffering of them in order to gate wide data buses late in the clock cycle. A state machine controlled application usually needs most of the clock cycle for decision finding, and control of dataflow function may have to be deferred to the next cycle. This deteriorates the control performance.

5. Delays of the control signal within the clock cycle are easy to predict: they are caused by gating of pipeline staged data with the pipeline valid signal. This simplifies the cycle time analysis of the control logic.

The Picoengine is composed of standard logical building blocks, such as Picocode RAM, pipeline stages etc., which simplifies the analysis of problems in the dataflow.

While the invention has been described in detail herein in accord with certain preferred embodiments thereof, many modifications and changes therein may be effected by those skilled in the art. Accordingly, it is intended by the appended claims to cover all such modifications and changes as fall within the true spirit and scope of the invention.

1. A central processing unit comprising:
a) a number of functional units (A, B, . . . , N);
b) at least one module for processing a function call received from one of the functional units, the module having:
a decoder to obtain an instruction address from the function call;
a memory for storing a plurality of control instructions and for storing a plurality of branch instructions, each control instruction having an assigned instruction address for a next instruction and each branch instruction having assigned at least two alternative instruction addresses for a next instruction;
a first logic circuit for processing the branch instructions in order to select one of the at least two alternative instruction addresses of one of the branch instructions; and
a second logic circuit for processing the control instructions in order to return a result in response to the function call.

2. The central processing unit of claim 1 wherein the functional units are instruction fetch or load/store units.

3. The central processing unit of claim 1 wherein the function call is selected from the group consisting of address translation, data compression, data encryption and data decryption function call.

4. The central processing unit of claim 1 wherein the module is adapted to return the result to the one of the functional units.

5. The central processing unit of claim 1 wherein the module is adapted to return the result to a predetermined other one of the functional units.

6. The central processing unit of claim 1 wherein at least one of the alternative instruction addresses of the branch instruction is the address of another one of the branch instructions.

7. The central processing unit of claim 1 wherein each branch instruction is assigned at least four alternative instruction addresses.

8. The central processing unit of claim 1 wherein the second logic circuit is adapted to operate with at least one pipeline stage.

9. The central processing unit of claim 1 wherein the control instruction has an assigned exceptional branch target address for addressing of an instruction in the memory in case an exception occurs in the second logic circuit.

10. A computer system comprising one or more central processing units in accordance with claim 1.

11. A method of processing a function call received by a module of a central processing unit, the method comprising the steps of:
a. decoding the function call in order to determine an instruction address in a memory of the module, the memory storing a plurality of control instructions and a plurality of branch instructions, each control instruction having an assigned instruction address for a next instruction and each branch instruction having assigned at least two alternative instruction addresses for a next instruction;
b. using the instruction address obtained by decoding the function call to access the instruction identified by the instruction address in the memory;
c. if the instruction is a branch instruction, processing the branch instruction by means of a first logic circuit in order to select one of the at least two alternative instruction addresses of the branch instruction as a next instruction; and
d. if the instruction is a control instruction, processing the control instruction by means of a second logic circuit in order to provide a result for the function call.

12. The method of claim 11 wherein the function is received from an instruction fetch or from a load/store functional unit.

13. The method of claim 11 wherein the function call is selected from the group consisting of a request for address translation, data compression, data encryption and data decryption.

14. The method of claim 11 wherein the result is returned to the functional unit from which the function call is received.

15. The method of claim 11 wherein the result is returned to a functional unit which is different from the functional unit from which the function call has been received.

16. The method of claim 11 wherein the next instruction is a branch instruction.
